(19) United States
(12) Patent Application Publication
(10) Pub. No.: US 2002/0138290 A1
(43) Pub. Date: Sep. 26, 2002

(54) System and method for enabling collaborative procurement of products in a supply chain

(75) Inventors: Sarah Metcalfe, Ottawa (CA); Lisa Carlin, Frederick, MD (US); Kurt A. Zarefoss, Middletown, MD (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Manugistics, Inc., Rockville, MD (US)

(21) Appl. No.: 10/014,789

(22) Filed: Dec. 14, 2001

Related U.S. Application Data
(60) Provisional application No. 60/255,156, filed on Dec. 14, 2000.

(51) Int. Cl. G06F 17/60

(52) U.S. Cl. 705/1

(57) ABSTRACT

A system and method for tracking, updating and sharing information related to a supply chain purchasing transaction. The system according to the present invention provides a means for creating corresponding delivery order when a purchase order is generated. The corresponding delivery order may be configured to have any number of attributes which allows users to monitor, update and control access to the information.

### CROSS REFERENCE TO RELATED APPLICATION

This application claims priority from U.S. Provisional Patent Application Serial No. 60/255,156 filed Dec. 14, 2000, the disclosure of which is hereby incorporated by reference in its entirety.

### FIELD OF THE INVENTION

The invention relates to a system and method for managing and sharing supply chain information. More specifically, the invention relates to a system and method for providing intelligent collaboration between supply chain buyers and sellers of products and/or services to enable intelligent procurement. The solution entails utilizing an electronic data network to allow buying and selling companies to quickly share intelligent purchasing data with vendors. All trading partners using the network may use the present invention to obtain configurable displays of order-level and item-level information for all permitted defined trading partners, from order origination to ultimate destination.

### BACKGROUND OF THE INVENTION

On any given day, businesses today are typically involved in a number of business transactions. Many of these transactions, for example, are purchasing transactions that occur within the context of a supply chain involving a buyer, a supplier and third parties such as a shipper or freight forwarder. It is often very difficult or impractical for many buyers to keep track of these purchasing transactions for several reasons including the shear number of transactions in which they may be involved at any given time makes it impractical. Buyers currently do not have a system for accomplishing such tasks. Unfortunately the pressures of today's competitive market is forcing many businesses to follow more closely the tracking of all their business transactions including purchasing transactions to ensure proper fulfillment of orders.

A purchasing transaction is the entire process of ordering goods and/or services, confirming the order, fulfilling the order, and transporting and delivering the ordered goods and services. Although many companies today have systems that facilitate the ordering of goods and/or services from other companies, they typically do not have in place a system that accurately and in real time tracks, updates and facilitates the sharing of information related to the entire purchasing transaction process. For example, in a typical purchasing transaction, a number of parties may be involved with the transaction such as a buying trading partner, a selling trading partner, and a freight forwarder (which may be the internal transportation division of the buying trading partner). These parties may have a particular interest in getting precise updated information relating to a specific purchasing transaction. Information such as need date, planned earliest delivery date, status of ordered goods, and the like. Unfortunately, although many companies today already have a Order Management System (OMS) in place, these systems have limited capabilities and are generally unable to monitor, track and update information relating to the entire purchasing transaction. That is, current systems often can only facilitate the ordering of goods and services but are often not designed to track the entire process of a purchasing transactions nor are they designed to facilitate the updating and exchange of selected information between multiple trading partners.

Several issues related to the tracking, updating and sharing of information relating to purchasing transactions makes such tasks at times vastly complex. For example, most trading partners would prefer that the type of accessibility to information related to a purchasing transaction be tailored to each situation. That is, accessibility may be restricted based on the identity of the party seeking the information and timing. For example, to prevent premature actions, it may be undesirable for a freight forwarder to have access to edit certain purchasing transaction information in advance of the freight forwarder receiving the requested goods. Thus, any system that is able to track, update and allow sharing of information relating to purchasing transactions will preferably be able to control the accessibility of the information based on multiple factors defining users.

Many of today's businesses already run a number of logistical applications. For example, an OMS application, a supply chain collaboration application, a monitoring application, a transport application, and the like, are some of the logistical applications that are typically run by today's businesses. These applications may work independently or may work as an integrated system. Both individually and as a group, these applications provide critical functional support to businesses. Therefore, it would be highly desirable to have a system that provides the tracking, updating and sharing of information related to purchasing transactions that can also relatively seamlessly integrate with other logistical applications.

### SUMMARY OF THE INVENTION

To solve the problems cited above, the present invention provides, among other things, a system and methods for tracking, sharing and updating of information relating to supply chain purchasing transactions. The present invention may supplement or may even replace preexisting OMS systems that many businesses already use. The system, according to the present invention, allows users to import a purchasing order from an OMS system and based on the purchasing order create one or more corresponding delivery orders. The delivery order may have attributes similar to those contained in the purchase order providing updateable information relating to the goods and/or services being ordered such as status. In an embodiment, the system may interface with other logistical applications such as a transport or a monitoring application.

In a preferred embodiment, filters may be used to control access to the purchase and delivery orders. The filters may be assigned to specific parties via roles or assigned enterprises. The filters may query for specific data based on attributes assigned to the purchase and delivery orders.

According to another embodiment, the purchase and delivery order may have a status attribute. The status attribute may allow users to control access to purchase and/or delivery orders. The status attribute may also allow business logic to be triggered.

According to another embodiment, data contained in the purchase order may be automatically copied into a newly created delivery order. Users have a choice of copying different amounts of data from the purchase order. For example, with a feature called “quick confirm,” the user may copy most of the data required for filling the delivery order. On the other hand, if the user elects not to quick confirm then the user may copy substantially less data then amount allowed under quick confirm. Without quick confirm, the user may specify what data to copy. After the copying step is performed, users may modify the data contained in the delivery order to fit the users' specific needs.

According to another embodiment, the delivery orders may be monitored for any changes. Once changes are detected, certain actions may be taken, for example, user notification regarding the changes.

According to another embodiment, a one-to-many attribute may be created for a delivery order. The one-to-many attribute allows different types of data to be used in the corresponding data fields in the delivery order.

According to another embodiment, a shipment may be created using data from two or more delivery order. This feature may allow users to better manage the delivery process.

As will be readily appreciated by one of ordinary skill in the art, the present invention provides for a robust system and method for sharing, tracking and updating of information relating to supply chain purchasing transactions. Additional features and advantages are set forth in the description that follows, and in part are apparent from the description, or may be learned by practice of the invention. The objectives and other advantages of the invention are realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1A is a block diagram of a system according to one embodiment of the present invention;

FIG. 1B is a block diagram depicting the system of FIG. 1B interfacing with various logistical applications;

FIG. 2 is a flow diagram depicting the steps in a method for creating a purchase order and its corresponding delivery order;

FIG. 3 is a block diagram depicting the relationship between a purchase order and its contents with a delivery order[s] and its contents;

FIG. 4A is a block diagram depicting the contents of an exemplary purchase order header;

FIG. 4B is a block diagram depicting the contents of exemplary line items;

FIG. 5A is a block diagram depicting the contents of an exemplary delivery order;

FIG. 5B is a block diagram depicting the contents of exemplary delivery lines;

FIG. 6 depicts an exemplary purchasing transaction involving a buyer, a supplier and a freight forwarder.

### DETAILED DESCRIPTION OF THE PREFERRED EMBODIMENTS

The invention disclosed herein incorporates by reference the subject matter of co-pending and commonly assigned U.S. Non-Provisional Patent Applications “System and Method for Supply Chain Management, Including Collaboration,” Zarefoss et al., attorney docket number 82001-0189, Ser. No. 09/965,854, filed on Oct. 1, 2001; “Shipping and Transportation Optimization System and Method,” Weber et al., attorney docket number 82001-0148, Ser. No. 09/903,855, filed on Jul. 13, 2001; “System and Method of Monitoring Supply Chain Parameters,” Zarefoss et. al., attorney docket number 82001-0199, Ser. No. 09/984,340, filed Oct. 29, 2001; and “System and Method for Supply Chain Demand Planning and Forecasting,” Singh et al., attorney docket number 82001-0193, Ser. No. 09/984,347, filed Oct. 29, 2001.

The present invention provides for a procurement system 100 (herein “the system”) and method that facilitates the sharing, tracking and updating of information relating to supply chain purchasing transactions. The system and method may be implemented using a combination of software and hardware components. Further, users of the system may be in communication with the system using an electronic network such as the Internet.

One of the primary ingredients for efficiently facilitating the sharing, tracking and updating of information according to the present invention is the generation of a corresponding delivery order[s] in response to the creation of a purchase order. A purchase order is an order or a request for goods and/or services. A purchase order will typically contain information needed to purchase goods and/or services, for example, information that identifies the goods or services being purchased, delivery destination, quantity, and the like. A delivery order is related to and similar to a purchase order, it contains delivery information such as origin, destination, planned delivery date, weight and containerization. Typically the purchase order is created by a system user who is on the buy-side of the purchasing transaction while the delivery order is generally created by a system user who is on the supply-side of the purchasing transaction. The corresponding delivery order may be linked to a purchase order by, for example, identifying in the delivery order, the purchase order to which the delivery order is linked. Similarly, the purchase order may also contain the identity of the delivery order[s] to which it is linked. This may be accomplished by, for example, creating a purchase or delivery order attribute in either the delivery or purchase orders.

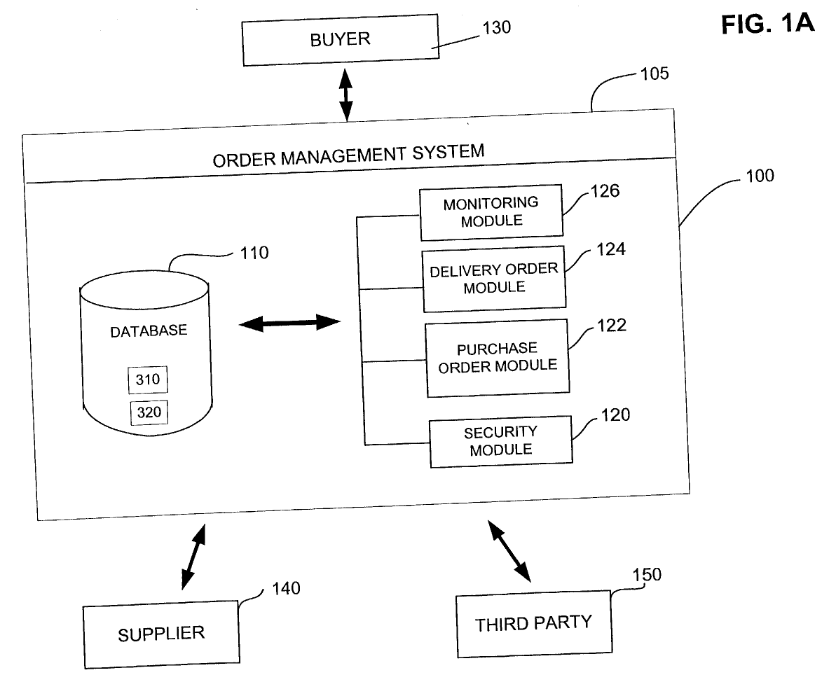

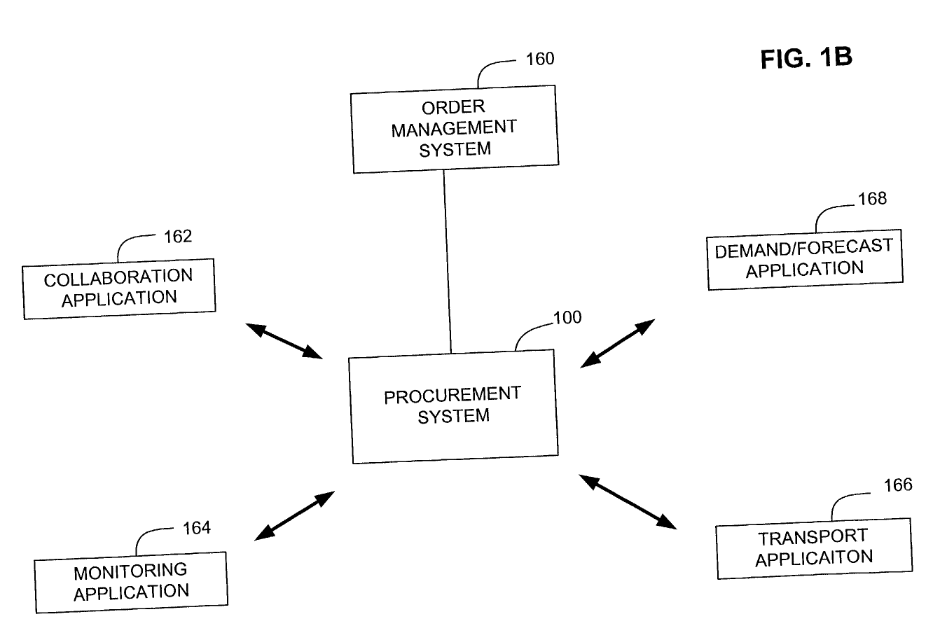

Referring to FIG. 1A, a procurement system 100 is depicted according to one embodiment of the present invention. The system 100 comprises of a database 110, a security module 120, a purchase order module 122, a delivery order 124 and a monitoring module 126. The system may be in communication with system users, such as buyers 130, sellers 140 and third parties 150 (e.g., a freight forwarder), and the like, via electronic networks such as the Internet, an intranet, an extranet, a Value Added Network (“VAN”), Virtual Private Network (“VPN”) and the like. The buyer 130 may be any person or organization belonging to the buy-side of a supply chain purchasing transaction. This may include, for example, an employee of the purchasing enterprise. In contrast, a supplier 140 is any person or organization belonging to the supply side of a supply chain purchasing transaction. This may include, for example, any employee of the supplying enterprise. The third party user[s] 150 may be any interested third party or parties, for example, a customer service representatives [CSR], a freight company or the transportation unit of the buyer or supplier enterprise responsible for transporting purchased goods. The system 100 may be located on a single server or on multiple servers. Further, the database 110 may be located separately from the system 100 on a separate server[s]. Although only one embodiment of the present invention is depicted in FIG. 1, those skilled in the art of computer science will recognize that the invention may be physically implemented in numerous ways. Thus, the specific embodiment depicted here is not intended to limit the scope of the present invention but is instead presented herewith for exemplary purposes only.

As previously described, the system may be located in one or more servers. Preferably the server, may be configured in a number of ways, for example, an NT 4.0 or HP-UX 11.0 server, Oracle 8.1.6.x, BEA Weblogic Application server 5.1, Java Runtime 1.2.x or 1.3.x and Java Plug-in 1.3.x. The client may run on various platforms, for example, Internet Explorer 4.0 or higher and Netscape 4.0 or higher. Those skill in the art will recognize that the above described platforms and/or applications may be replaced with similar platforms and/or applications or a modified or newer version of the same platform/application.

Through the use of the security module 120, each user 130 to 150 will have varying degrees of access and privileges to data stored by the system 100. User access and privileges to purchase orders and delivery orders stored in the system 100 will generally depend on the enterprise that a user is associated with and the role[s] assigned to that user. Generally, associated with each enterprise and each role are filters. Filters define what type of access that a user may have to specific data stored in the system, for example, purchase orders and delivery orders. Filters are also used to direct users to specific purchase and delivery orders. The filters may be modeled so that they query for specific purchase and/or delivery orders based on the purchase and delivery order attributes. For example, when a supplier 140 first logs on to the system 100, the system will retrieve the filters (e.g., supplier's enterprise and role filters) assigned to the supplier 100 and will query through the database 110 seeking only those purchase orders that designates the supplier 140 as the designated supplier in the designated supplier attribute data field. Further, users (and system administrators) may also create customized filters to query for specific data. Further discussion relating to filters and roles may be found in the above referenced U.S. Patent Applications.

The purchase order module 122 allows users (typically the buyer 130) to import and review purchase orders. Purchase orders is typically first created by an external Order Management System (OMS) 105 and are imported into the system 100. Alternatively, the OMS system 105 may be completely integrated into the procurement system 100 resulting in the procurement system 100 having the functional role of creating or defining the purchase order. The attributes of a purchase order may include, for example, purchase order numbers, designated supplier, and desired delivery date.

The delivery order module 124 allows users (typically the supplier 140) to create corresponding delivery order[s]. Similar to purchase orders, corresponding delivery orders must be defined by many of the same attributes. Thus, the delivery order module 124 allows users to create delivery order attributes. The delivery order attributes may include, for example, associated purchase order number, delivery order number, planned delivery date, and status. Once the attributes are created, the module 124 allows users (which may include other parties other then suppliers 140) to update the delivery order. The creation of delivery orders is described in greater detail below.

In another embodiment, the system 100 may also include a monitoring module 126. The monitoring module allows users to track changes to purchase and delivery orders. The module 126 detects purchase orders that have been newly imported and changes to delivery orders. Once such events are detected, the system may take certain actions such as notifying users of the changes and/or change accessibility to the purchase and delivery orders by users. The module 126 may be configurable so that users may select the triggering events which results in a business logic being executed. The system 100 may also interface with an external monitoring applications such as described in “System and Method of Monitoring Supply Chain Parameters,” Zarefoss et al., attorney docket No. 82001-0199, Ser. No. 09/984,340, filed Oct. 29, 2001.

The system 100, working together with other logistical applications, facilitates the exchange and maintenance of information used in supply chain purchasing transactions. Referring to FIG. 1B depicting the system 100, according to one embodiment, interfacing with various other logistical applications 160 to 170. For example, the system 100 may interface with a buyer via an OMS 160. The system 100 may also interface with other logistical applications such as: a supply chain collaboration application 162; a supply chain monitoring application 164; a transport application 166; and a demand and forecasting application 168. Details of these applications may be found in the above-referenced co-pending U.S. Patent Applications. These applications may interact and share information needed to provide efficient and timely logistical support for running a supply chain enterprise.

The system 100 is preferably able to interface with an external OMS 160. Many of today's businesses employ an order management system, which may interconnect various divisions within a company. The OMS system generally tends to be part of an external accounting system that facilitates the ordering of goods for an enterprise. The system 100 according to the present invention is able to interface with these OMS systems, thereby allowing the enterprises to exchange information with outside parties including suppliers and thereby keeping track of any purchasing transaction from order creation to delivery.

Another feature of the system 100, according to one embodiment of the present invention, is its ability to interface with other logistical application providing broader logistical support to users. For example, the system 100 may interface with a monitoring application 164 such as Manugistics' NetWORKS Monitor. The system 100 may allow user notification via the monitoring application 164 when a purchase order or delivery order status has been changed. The business rules that may trigger a notification are configurable and may be supplied b the monitoring application. Further details relating to a monitoring application may be found in “System and Method of Monitoring Supply Chain Parameters,” Zarefoss et al., attorney docket number 82001-0199, Ser. No. 09/984,340, filed Oct. 29, 2001.

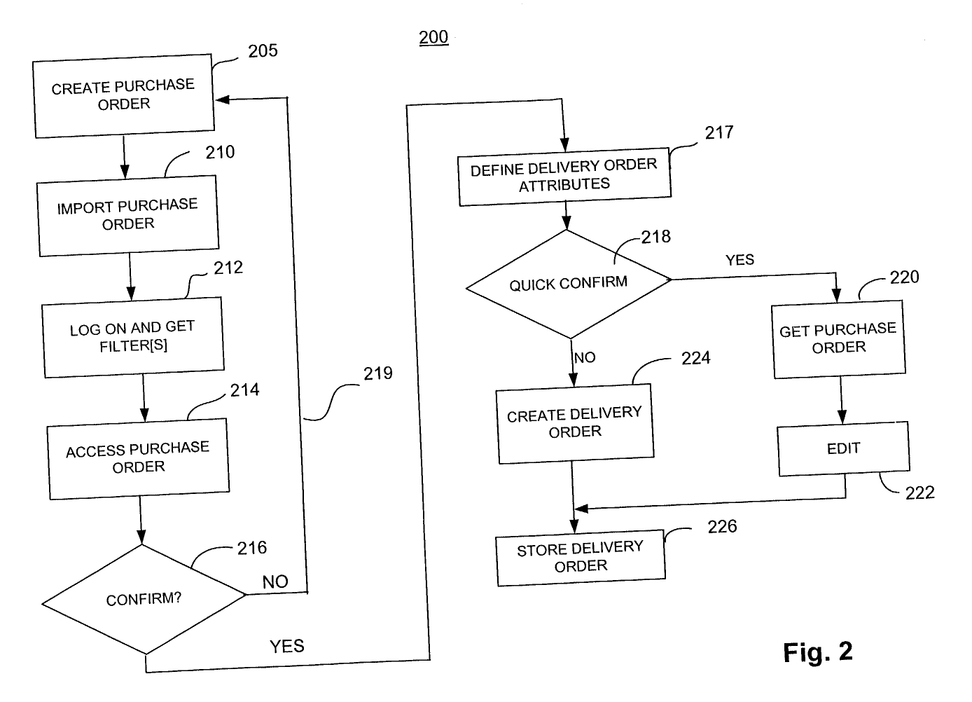

FIG. 2 depicts a process 200, in accordance with one embodiment of the present invention, for generating a purchase order and corresponding delivery order[s]. At step 205, the purchase order is created by the buyer 130 by filling data into the empty fields for the various attributes used to define the purchase order “form” (a more detailed discussion relating to attributes used to define purchase orders is discussed below). Typically, this is accomplished in an OMS system. At step 210, the system 100 imports the data for the purchase order from the OMS system and stores the data in the database 110. Companies today often employ an OMS system to order goods and services. These OMS systems will typically interface with other logistical applications or systems, for example, an accounting application. By inputting the data through an OMS system, the data needed to fill the purchase order data fields may be acquired from the OMS system. The purchase order that is created will typically identify a designated supplier, which allows the designated supplier to eventually view the purchase order. Optionally, the supplier will be informed via an automated e-mail that there are new purchase orders for him to view. At step 212, the designated supplier 140, logs on to the system 100 and based on the supplier's ID, appropriate security filters are retrieved. The retrieved filter[s] generally allows the supplier 140 to view only those purchase orders that designate the supplier 140 as the designated supplier. After reviewing the purchase order, the supplier 140 may choose to confirm or not to confirm the purchase order at step 216. If the supplier rejects the purchase order, then the buyer must create a new purchase order, designating a new supplier, as indicated by 219. If the supplier decides to confirm, then confirmation of the purchase order may be accomplished in a number of ways. The supplier may also confirm a portion of a purchase order. The buyer then creates a new purchase order as needed to fulfill the remaining order. Confirmation may be made by creating a delivery order for the corresponding purchase order. The delivery order is then stored in the database 110. Once stored, the buyer 130 may then view the delivery order to see if the purchase order has been confirmed. The supplier 140 may also reject the purchase order simply by changing the status of the purchase order to “Rejected.” Notice of confirmation or rejection of the purchase order may also be accomplished through the automatic sending of notice via, for example, email, voicemail, and the like. After the supplier 140 decides to confirm the purchase order, the delivery order must be characterized by defining its attributes at step 217. If the supplier 140 chooses not to confirm the purchase order then the buyer 130 must create a new purchase order manually or edit the existing purchase order as indicated by 219. Although not shown in this flow process 200, a message alerting the buyer 130 that the purchase order has been rejected may be sent to the buyer 130 via, for example, email or other equivalent means when the purchase order has been rejected by the supplier 140. The system may monitor the purchase orders stored in the database 110 and if the system 100 determines that the status of a purchase order has been changed to “rejected,” a business logic may be triggered which requires the system 100 to send an alert to the buyer notifying the buyer that the purchase order has been rejected. The system 100 retrieves the original purchase order and uses the data contained in the original purchase order to fill the data fields of a new delivery order at step 220. If the supplier 140 decides to confirm the purchase order then the supplier 140 must choose whether to “quick confirm” the purchase order at step 218. If the supplier 140 decides to quick confirm the purchase order, after the data fields have been filled, with quick confirm, the supplier 140 may refine a small number of attributes on the delivery order by editing it at step 222. If, on the other hand, the supplier 140 chooses not to quick confirm, then the data fields of the delivery order may still be partly or fully filled using imported data from the purchase order but must at least be modified and refined extensively at step 224. Alternatively at step 224, the user may manually fill the delivery order data field. At step 226, the completed delivery order is stored and made accessible to the buyer at step 226. A more detailed discussion regarding specific steps in the above process 200 and the various features of the present invention is described below.

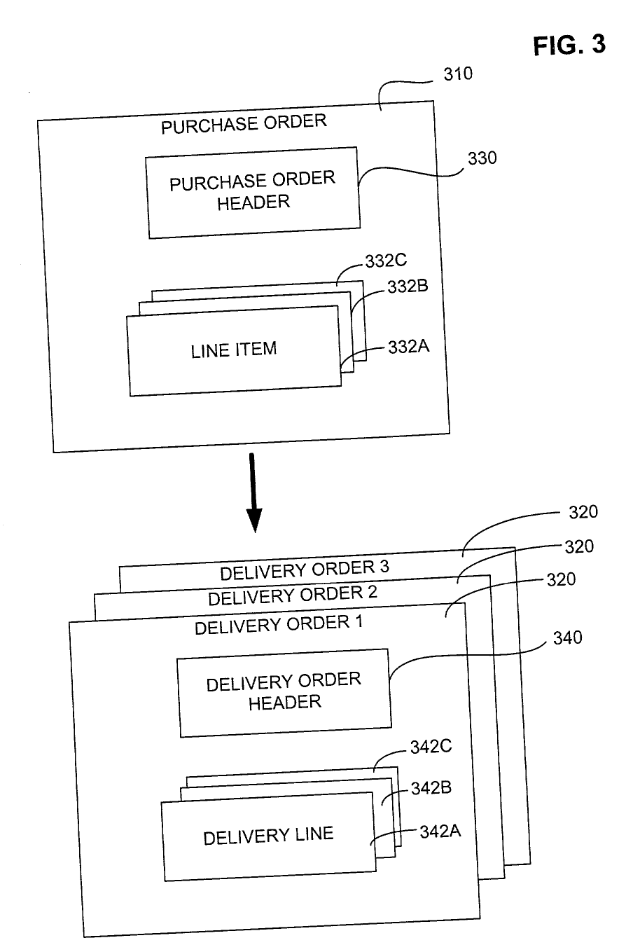

FIG. 3 shows the two primary components according to the present invention: a purchasing order 310, which is generally created by the buyer 130; and the delivery order 320, which is generally created by the supplier 140 as a result of accepting or confirming the purchase order 310 (e.g., using method 200). Each purchase order 310 is associated with one or more delivery order 320. A supplier may have certain restrictions, which may prevent a single delivery order 320 from being able to fulfill the requirements of the corresponding purchase order 310. For example, suppose a warehouse for the supplier 140 does not have all the items requested in the purchase order 310 and as a result, some of the requested items have to be shipped from a second warehouse or shipped at a later date. Typically all of the items listed on a single delivery order 320 come from a single origin (e.g., a warehouse). In such a situation, multiple delivery orders 320 will typically be needed to fulfill the requirements of the purchase order 310. The delivery orders 320 generated as a result of a purchase order 310 may be linked to the original purchase order by identifying the identifier of the original purchasing order 310 such as a purchase order number in the delivery order 320.

In one embodiment, each purchase order 310 comprises of a purchase order header 330 and one or more line items 332A to 332C. The data contained within the header 330 is general information relating to order and shipping arrangements that are globally applicable to all the purchase order line items 332A to 332C. For example, purchase order header 330 may include, for example, the purchase order number, the identification of the designated supplier, the desired delivery date, desired delivery site and summary of status of any underlying delivery orders. Each line item 332A to 332C is specific to specific goods and/or services that are requested under the purchase order 310. Data contained in line items 332 are product specific and typically indicate the quantity and timing for each of the goods specified among other things. This information, unless edited by further import of modifications from the OMS, generally remains intact as the original request information throughout the entire purchasing transactional period. As previously described, the purchase order 310 will be viewable by the designated supplier.

After reviewing the purchase order 310, the designated supplier may generate one or more delivery orders 320. A delivery order 320 comprises of a delivery order header 340 and one or more delivery lines 342A to 342C. The delivery order 320 contains data relating to the supplier-side of a purchasing transaction. The data contained in the delivery order 320 is organized into a delivery order header 340 and one or more delivery lines 342A to 34C. The data contained in the delivery order header 340 is generally applied globally to all of the corresponding delivery lines 342A to 342C. Examples of the type of data that may be included in the delivery order header includes, for example, the corresponding purchase order number, origin, planned earliest available date, planned latest delivery date, and status. Each delivery line 342A to 342C corresponds to specific goods and/or services and will typically mirror the goods and/or services in the line item[s] 332A to 332C in the corresponding purchase order 310.

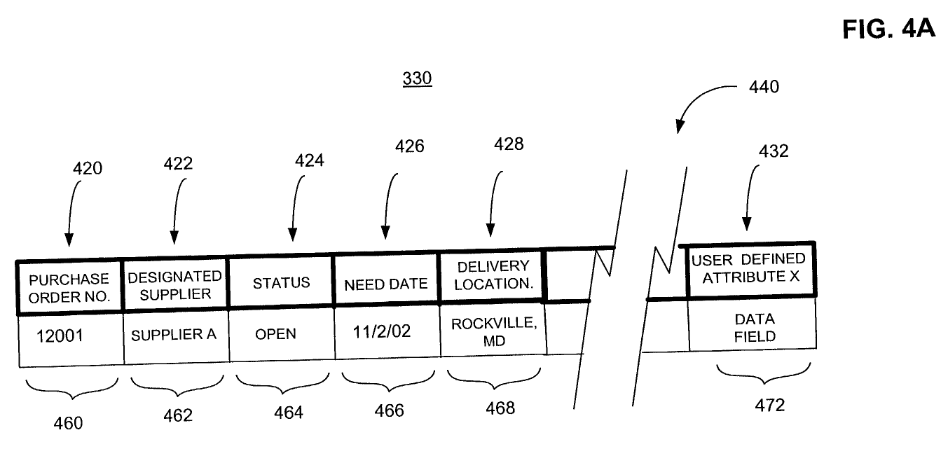

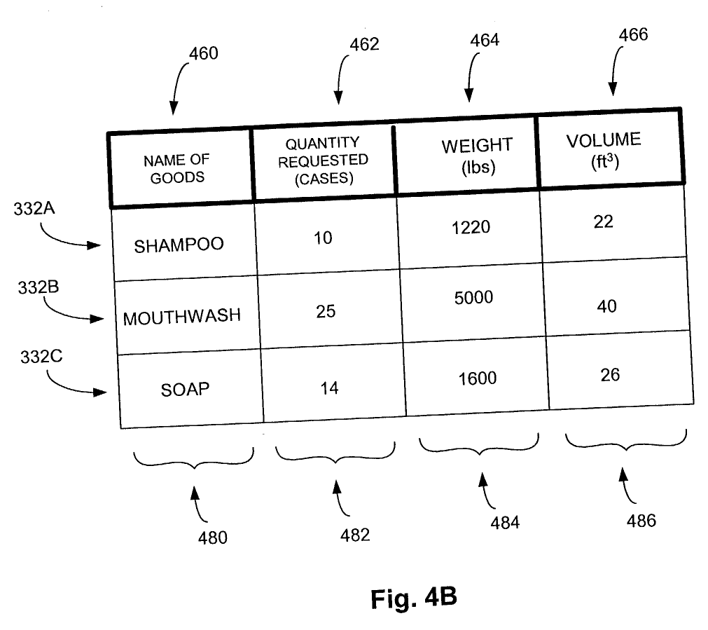

Referring now to FIG. 4A, the contents of an exemplary purchase order header 330 are shown. Attributes 420 to 428 are preferably created when the purchase order is initially defined. Attributes that apply globally to all line items 332A to 332C of a purchase order 310 will generally be included in the purchase order header 330. In addition, any number of user defined attributes 420 to 432 may be created based on user needs as indicated by 440. Six attributes are specifically depicted here: a purchase order number attribute 420; designated supplier attribute 422; status attribute 424; need date attribute 426; delivery location attribute 428 and user defined attribute X 432. Certain attributes are generally required to facilitate the various functional capabilities of the system 100. For example, preferably a purchase order header 330 would include a way to identify the purchase order 310, for example, by including a purchase order number attribute 420 as depicted in FIG. 4A. Attributes, such as the status attribute 424, need date attribute, and the like, are also preferably included in the header 330. Other attributes may also be included at the discretion of users. When a purchase order 310 is created in the OMS, the attribute fields 460 to 468 are preferably filled, typically by the buyer 130. In this case, the number “12001” has been inserted into the purchase order number field 460. Similarly, “supplier A” has been inserted into the designated supplier field 462, a “open” inserted into the status field 464, the date “11/2/02” inserted into the need date field 466, and so forth. Generally most of the fields 460 to 470 will only be read-only. However, certain fields may be accessible for editing by the buyer. For example, the buyer may be given permission to modify a particular user defined attribute such as status.

Referring to FIG. 4B depicting a detailed view of the line items 332A to 332C of FIG. 3. As with the purchase order header 330, the line items 332A to 332C may be further defined by attributes 460 to 466. Any number of user defined attributes may be used in defining line items 332A to 332C. In this example, four attributes are shown, name or goods attribute 460, quantity requested 462, weight 464 and volume 466. When the purchase order 310 is actually created, the data fields (as shown in columns 480 to 486) is preferably filled. Each row, 332A to 332C, represents a line item. In this case, the three items being ordered in the purchase order 310 are shampoo, mouthwash and soap as indicated in column 480. As indicated in column 482, the purchase order 310 requests 10 cases of shampoo, 25 cases of mouthwash and 14 cases of soap. In addition to the number of cases requested, other quantity information such as weight and volume data (as depicted in columns 484 and 486) related to the requested items may be included. Such information may be relevant to, for example, one or more of the users (i.e., buyer, supplier and/or third parties) because of the consideration that must be given to weight and volume restrictions relating to transportation and storage.

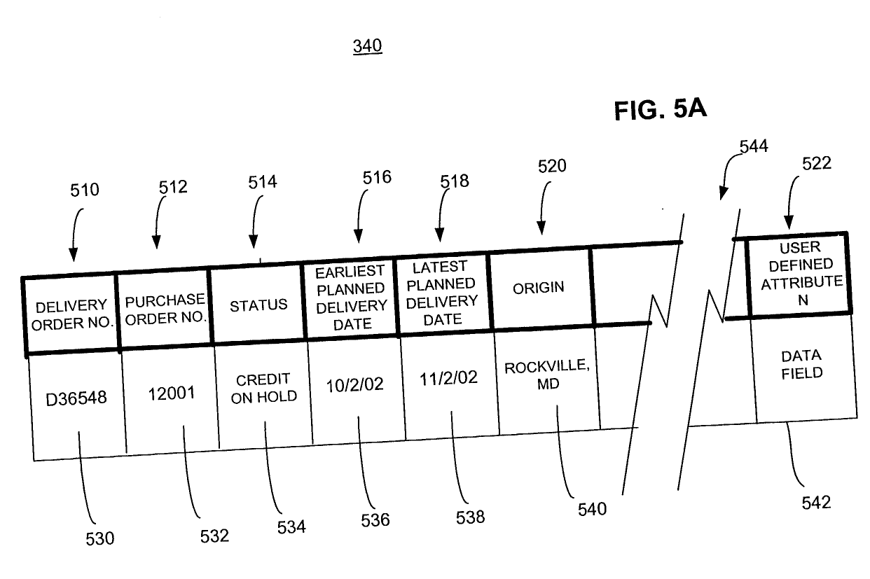

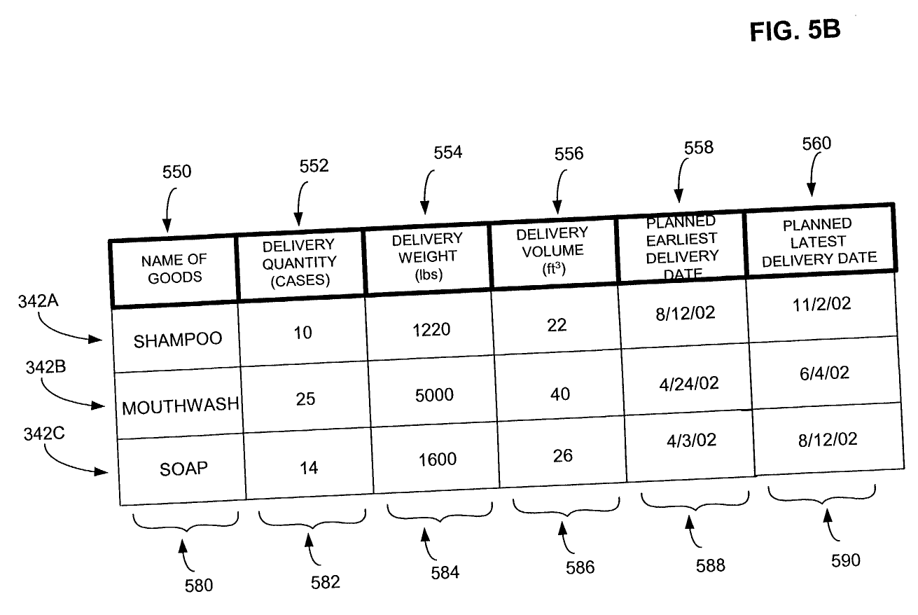

Based on a purchase order 310, one or more delivery order 320 may be generated typically by the designated supplier. Referring to FIG. 5A depicting an exemplary purchase order header 340. As with the purchase order header 330, attributes 510 to 522 may be created for the delivery order header 340. As with the purchase order 310, certain attributes created for delivery orders 320 are generally required for the functionality of the system 100. For example, the delivery order number attribute 510 may be used to identify the delivery order 320. A purchase order identifier attribute 512 may be used to associate the delivery order 320 to the corresponding purchase order 310. Other attributes that are preferably used to define a delivery order include status 514, latest delivery date 518 and origin 520. To complete the creation of the delivery order 320 data is preferably inserted into data fields 530 to 540. In this example, “D36548” has been inserted into the data field 530 for the delivery order number. “12001” has been inserted into the data field 532 for the corresponding purchase order number. “Credit on hold” has been inserted into the data field 534 for the status of the delivery order. “11/2/02” has been inserted into data field 536 for the earliest planned delivery date. “11/2/02” has been inserted into the data field 538 for the latest planned delivery date. “Rockville, Md.” has been inserted into the data field 540 for the origin. Any number of user defined attributes may be created for the purchase order header 340 based on user needs as indicated by 544. Typically some or much of the information contained in the delivery order header data fields 530 to 542 will mirror the data in the purchase order header data field 460 to 472. For example, the “need date” data field 466 for the purchase order header 330 in FIG. 4A matches the data contained in the delivery order “latest planned delivery date” data field 538 in FIG. 5A. Thus, much of the information contained in the delivery order header 340 may be automatically copied directly from the purchase order header 330. This characteristic allows the system 100 to provide for the copying capabilities of the “quick confirm” feature (as well as the copying capabilities when quick confirm is not selected).

The system 100 may provide for a special attribute called “One-to-Many” user defined attributes to be created for delivery orders. When a One-to-Many attribute is created in, for example a delivery order header, various types of data can be used to fill the One-to-Many attribute (e.g., a combination of quantitative as well as qualitative types of data). For example, suppose there exists a One-to-Many attribute called “charges” that relates to how the delivery order is to be paid. The corresponding data field may be filled with, for example, data relating to description of the charges, amount of charges and method of payment. These One-to-Many attributes may be created by linking these attributes to other user defined attributes. For example, in the above illustration, the data relating to description of the charges may actually be stored in a attribute called “charge description” while the data for the amount of charges may be stored in a attribute called “charge amount.” Referring now to FIG. 5B showing a detailed view of the delivery lines 342A to 342C of the delivery order 320 in FIG. 3. Since a delivery order 320 is typically created in response to a purchase order 310, as expected, the delivery lines 342A to 342C of the delivery order 320 will generally correspond one to one with the line items 332A, 332B and 332C in the purchase order 310. Although in this example, there is indeed one to one correspondence between the delivery lines 342A to 342C, and the line items 332A, 332B and 332C, this will not be the case in all situations. For example, if for some reason all of the delivery lines 342A to 342C cannot be shipped as a single delivery then one or more new delivery order (one for each delivery on the purchase order) must be created for the balance of delivery lines. For example, if there is a restriction on the quantity of a specific goods that can be listed in a delivery order 320 then additional delivery order[s] 320 may be required. The delivery lines 342A, 342B and 342C in this embodiment is created or defined by six attributes: name of goods (identifier) attribute 550; delivery quantity attribute 552; delivery weight attribute 554; delivery volume attribute 556; planned earliest delivery date attribute 558; and planned latest delivery date 560. Any number of additional user defined attributes for delivery lines 342A to 342C may be created to accommodate user needs, for example, an attribute such as a delivery line identification number attribute may also have been included. Once the actual delivery order 320 is created and prepared for submission, the data fields (as indicated by columns 580 to 590) is preferably filled.

Another feature of the system 100, according to the present invention, is its ability to combine multiple purchase order line items 332A to 332C across different purchase orders 310 into one shipment. A shipment typically comprises of several line items 332A to 332C. These line items 332A to 332C are actually delivery lines 342A to 342C but is generally transparent to the user. Each of these line items may be further refined to indicate actual packaging composition of the shipment. Users may specify the number of packages, and associated with each package, the number of cases. Serial numbers are then associated with each individual case. These serial numbers may be generated by the system 100 or provided by the user.

Once a delivery order 320 has been created by filling the data fields for both the delivery order header data fields 530 to 542 and the delivery order delivery line data fields 580 to 590, the delivery order 320 may be locked to prevent any further editing. For example, if a supplier confirms a purchase order by creating a delivery order and scheduling an order, the supplier may choose to lock the delivery order 320 so that no further editing can be done on the scheduled delivery order 320. Because a delivery order 320 is linked to a specific purchase order 310, if the purchase order 310 is cancelled then all the delivery orders 320 associated with the cancelled purchase order will also cancel unless the delivery order 320 is locked. These features may help to prevent a supplier 140 from fulfilling a purchase order 310 that has been cancelled and also prevents the buyer 130 from reneging on a delivery order 320 that is already committed.

Certain advantages may be realized by keeping certain qualitative type data stored separately in the purchase or delivery order header while keeping certain quantitative data at the line item or delivery line level. For example, by using the purchase order header 330 or delivery order header 340 to store certain qualitative data, the system 100 allows global changes to be made on the qualitative data (e.g., destination, origin, requested earliest available date, requested latest delivery date, status, planned delivery date, and the like) for all line items 332A to 332C or delivery lines 342A to 342C. If specific changes need to be made on certain quantitative data related to specific goods or services, then the changes may be made at the line item level.

If there is a need to make changes to qualitative data related to specific delivery lines 342 or line items 332, then the delivery line 242 or line item 232 are preferably moved to another delivery order 220 or purchase order 210. This is because changes to qualitative data associated with specific delivery lines and/or line items are preferably done at the purchase or delivery order header level. Thus, any changes that are made to either the purchase or delivery order headers will have a global effect on all line items or delivery lines belonging to the same purchase or delivery order. A more detailed discussion relating to certain features of the present invention is further described below.

In addition to helping control access to purchase orders 310 and delivery orders 320, filters provides other useful functionality. Filters may control access to specific data (e.g., purchase and delivery order) and direct users to specific data by exploiting the user defined attributes created in organizing and defining purchase and delivery orders. For instance, to restrict a supplier's access to only those purchase orders that are meant for that supplier 140, the supplier 140 will be assigned to filters, which queries for only those purchase orders 310 that designate the supplier 140 as the designated supplier in the designated supplier attribute data field 462. Further, access to purchase orders 310 by a specific employee or associate of the supplier 140 will be based upon the filters assigned to the supplier 140 (i.e., enterprise filters) and filters assigned to that employee (i.e., user filter). A user who is on the purchasing side of the purchase transaction, such as an employee of the buyer enterprise, on the other hand, will be able view and/or edit all of the purchase orders for their enterprise or perhaps only for a specified product lines. The filters may be associated with specific role[s]. The roles are then assigned to specific users, allowing the users to access particular purchase orders depending upon the filters assigned to those role[s]. Further information relating to filters and roles and the use of filters to provide security and data access may be found in “Method and System for Supply Chain Management Including Collaborate,” Zarefoss et al., attorney docket number 820010189, Ser. No. 09/965,854, filed Oct. 1, 2001.

The system allows users to quickly create delivery orders 320 using a feature called “quick confirm.” When a supplier 140 accesses a purchase order 310 that has designated the supplier 140 as the designated supplier, the supplier 140 may choose to confirm the purchase order 310 by building up a delivery order[s] or by using quick confirm. By using quick confirm, the delivery order data fields (columns 530 to 540 for the purchase order header and columns 580 to 590 for the delivery lines) may be completely filled by copying the original data contained in the purchase order 310. A Quick Confirm allows the supplier to quickly indicate that tentatively everything outstanding on the purchase order will be delivered. Exact details of what, how much, and where items were sent from are specified at a later date using an exiting external system at the shipping dock. This data is then exported from the shipping dock system into procurement, and procurement updates the tentative quick confirm delivery order with the actual details of what was shipped.

One of the key attributes useful for implementing the various features of the system 100 according to the present invention is the status attribute. A status attribute may be created for both purchase orders 310 and delivery orders 320 in the purchase order header 340 (thus globally applicable to all line items), in the delivery order header 320 (thus globally applicable to all delivery lines), the line items 332 and/or the delivery lines 342. The procurement system administrator may create any number of statuses depending on the buying enterprise's needs. For example, examples of the types of purchase order status that may be created includes: “Deleted”, “Rejected”, “Hold”, “Viewed”, “In-Progress”, “Fully Built”, and “Confirmed.” Similarly, a number of delivery order statuses may also be created. For example, examples of the types of purchase order status that may be created includes: “In-Progress”, “Scheduled”, “Shipped”, “In-Transit”, “Ready For Shipment”, “Credit Hold”, “Credit Approved”, “Commit” and “Received.” Each status created may be designed to trigger a business logic or control access to specific data stored in the system 100.

One way that the status attribute adds functionality to the system 100 is that it allows users to control accessibility to specific data based on events. For example, when a buyer 130 is in the process of creating a purchase order 310, the purchase order status may be set on a “hold” status. The hold status may allow the supplier 140 to view the purchase order 310 but may prevent the supplier 140 from being able to create a corresponding delivery order 320 for the purchase order 310 that has a hold status. As a result, a premature response from the supplier 140 may be avoided. The status of the delivery order 320 may also assist the supplier 140 from taking certain actions that are undesirable. For example, if the purchasing transaction is based on credit then credit statuses, for example “Credit Hold” or “Credit Approved” may also be included as a possible delivery order status. By monitoring the delivery order status, an employee of the supplier or other logistical applications such as a manufacturing scheduling application that interfaces with the system 100, can determine when to proceed with actions needed to fulfill the delivery order 320. As long as the delivery order status is on “Credit Hold”, the employee or the scheduling application may be prevented from proceeding with any actions related to the delivery order 320. Only when the status has changed to “Credit Approved” will the employee or the scheduling application proceed with any action related to the delivery order 320. The usefulness of such a status is not only beneficial to the supplier 140 but also to the buyer 130. By monitoring the status attribute of the delivery order 320, the buyer is able to track the progress of the delivery order 320.

The status attribute (as well as other user defined attributes) may be used to trigger business logic. For example, suppose the status of a delivery order 320 has been changed to “confirmed,” which indicates that the supplier 140 has committed to fulfilling the delivery order/purchase order. The system 100 may then review the delivery order 320 and determine if the delivery order 320 fully satisfies the requirements of the corresponding purchase order 310. If the delivery order 320 does not satisfy the purchase order requirements, for example when the quantity of ordered goods listed under the delivery order 320 falls short of the quantity of goods requested under the purchase order 310, then the system 100 may take certain actions based on user defined business rules. These actions may include, for example, an automatic buyer notification, such as an email, notifying the buyer 130 about the discrepancy and/or automatically generating another delivery order 320 to make up the difference between the purchase order 310 and the original delivery order 320. Alternatively, the supplier may create a new delivery order 320 to make up the difference between the purchase and delivery orders. This may be accomplished, for example, by automatically copying certain data from the original delivery order 320 to the new delivery order 320 and editing certain portions of the data such as the quantity of goods or services being ordered.

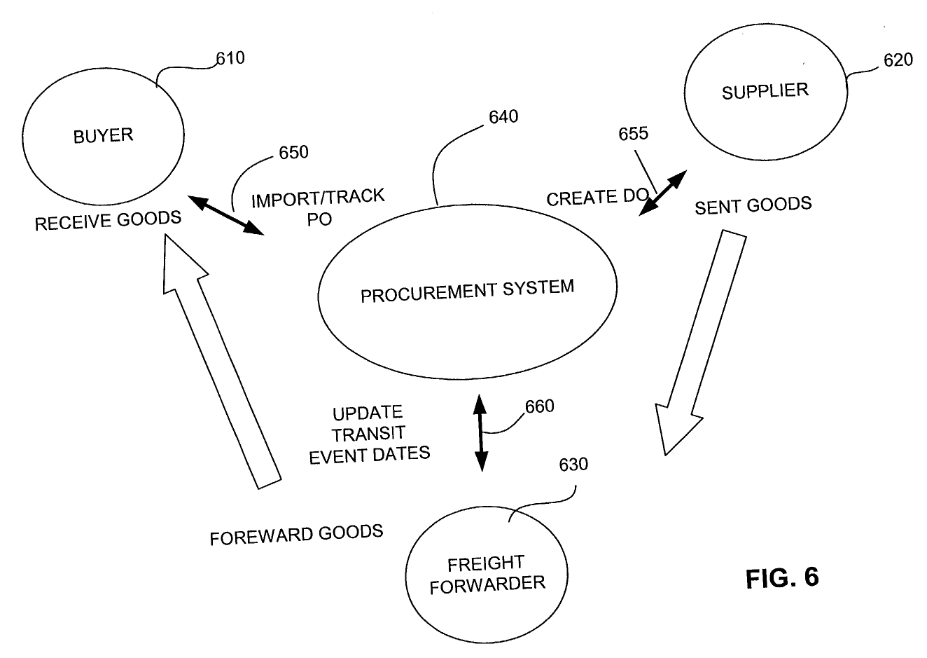

The various features of the present invention may be better understood with the following example. Referring to FIG. 6 depicting an exemplary process for the creation and exchange of a purchase order and corresponding delivery order. In this example, three parties, a buyer 610, a supplier 620, and a freight forwarder 630 are in communication with a procurement system 640 in accordance with the present invention. Initially the buyer 610 may import a purchase order (PO) as indicated by 650. The data for the purchase order may be inputted through an OMS system that interfaces with or operates concurrently with the procurement system 640. The purchase order is then stored in the procurement system 650 and the buyer 610 is able to track the purchase order through the system as indicated by 650. The supplier 620 is notified by email of a new purchase order for him and then logs onto the procurement system 640 and based on the filter[s] assigned to the supplier 620, is allowed to access the purchase order. The supplier confirms the purchase order[s] by creating a corresponding delivery order[s] as indicated by 655. Once the delivery order[s] has been created, the freight forwarder 630 may be given access to view but not edit the delivery order. Access to the delivery order[s] by the freight forwarder 630 may be granted by naming the freight forwarder 630 as the designated freight forwarder in the delivery order. This may be accomplished by creating a third party attribute called “freight forwarder attribute.” By indicating a specific freight forwarder 630 in this attribute, the specific freight forwarder 630 may be granted limited access to the delivery order. The access to the delivery order by the freight forwarder may be further controlled by the status of the status attribute. For example, if the status of the delivery order is not in the correct status such as “ready for pickup” or “ready for shipment” then the freight forwarder may be restricted to only view only access and no editing access. The procurement system 640 may also notify the buyer 610 of the confirmation by sending the buyer 610, for example, an email. Once the requested goods are ready for delivery, the supplier 620 may change the status of the delivery order to “ready for delivery.” The status change will trigger a business logic, which may grant expanded authority by the freight forwarder 630 to edit the status data field. This will allow the freight forwarder 630 to change the status, for example, to “goods in transit.” The freight forwarder 630 may also be allowed to change other data fields within the delivery order. For example, the delivery order may have an attribute for information related to transit events called “track and trace.” The freight forwarder 630, upon the status being set at “goods in transit” may be authorized to update the data field for the transit events as indicated by 660. While the requested goods are in the possession of the freight forwarder 630, the freight forwarder 630 may also have the authority to edit the status data fields for both the purchase order (but not the purchase order in the current system) and delivery order. When the goods are finally delivered to the buyer, the freight forwarder 630 may change the statuses to “delivered” notifying all concern parties of the final status of the purchasing transaction.

Although the above example depicts only three participants, i.e., buyer, supplier and freight forwarder, the dynamic nature of the system allows for any number of participants to participate in these purchase/delivery transactions. Further, using business logic and filters, users are able to control the access to the purchase and delivery orders by each party based on specific events and status of the transaction.

The foregoing description of the preferred embodiments of the present invention has been presented for the purposes of illustration and description. It is not intended to be exhaustive or to limit the invention to the precise form disclosed. It will be apparent to those of ordinary skill in the art that various modifications and variations can be made in the supply chain management system and method of the present invention without departing from the spirit or scope of the invention. Thus, it is intended that the present invention covers the modifications and variations of this invention provided that they come within the scope of any claims and their equivalents.

We claim:

1. A method for sharing, tracking and updating supply chain purchasing transactional information, comprising the steps:
importing a purchase order having one or more user defined attributes, wherein said purchase order is associated with a first supply chain trading partner; and
creating a corresponding delivery order having one or more user defined attributes, wherein said corresponding delivery order associated with a second supply chain trading partner, said delivery order being accessible by said first trading partner.

2. The method according to claim 1, further comprising the step of creating a configurable status attribute for said delivery order.

3. The method according to claim 1, wherein said step of creating said corresponding delivery order further includes the step of importing data from said purchase order into said delivery order.

4. The method according to claim 1, further comprising the step of monitoring for changes to data contained in said delivery order.

5. The method according to claim 4, further comprising the step of comparing said changes to said data and determining whether a business rule has been violated.

6. The method according to claim 5, further comprising the step of notifying one of said trading partners when a business rule has been violated.

7. The method according to claim 1, further comprising the step of creating a filter configured so that said filter allows a third trading partner to access said delivery order based on a third party attribute in said delivery order.

8. The method according to claim 1, further comprising the step of creating a filter configured so that said filter allows a third trading partner to access said delivery order based on a status attribute in said delivery order.

9. The method according to claim 1, further comprising the step of making accessible data contained in said delivery order to a logistical application.

10. The method according to claim 9, wherein said logistical application is a transport application.

11. The method according to claim 9, wherein said logistical application is a monitoring application.

12. The method according to claim 1, wherein said delivery order corresponds to said purchase order based on a purchase order attribute for said delivery order.

13. The method according to claim 1, further comprising the step of creating a one-to-many attribute in said delivery order.

14. The method according to claim 1, further comprising the steps of creating a shipment using data from two or more purchase orders.

15. A system for sharing, tracking and updating supply chain purchasing transactional information, comprising:
a means for importing a purchase order having one or more user defined attributes, wherein said purchase order associated with a first supply chain trading partner; and
a means for creating a corresponding delivery order having one or more user defined attributes, wherein said corresponding delivery order associated with a second supply chain trading partner, said delivery order being accessible by said first trading partner.

16. The system according to claim 15, further comprising a means for creating a filter, said filter assigned to said second trading partner and configured to query for said purchase order based on a designated supplier attribute contained in said purchase order.

17. The system according to claim 15, wherein said means for creating a corresponding delivery order further comprises a means for creating a configurable status attribute for said delivery order.

18. The system according to claim 15, wherein said means for creating said corresponding delivery order further comprises a means for importing data from said purchase order into said delivery order.

19. The system according to claim 15, further comprising a means for monitoring for changes to data contained in said delivery order.

20. The system according to claim 19, wherein said means for monitoring further comprising a means for comparing said changes to said data and determining whether a business rule has been violated.

21. The system according to claim 20, further comprising a means for notifying one of said trading partners when a business rule has been violated.

22. The system according to claim 15, further comprising a means for creating a filter configured so that said filter allowing a third trading partner to access said delivery order based on a third party attribute in said delivery order.

23. The system according to claim 15, further comprising a means for creating filter configured so that said filter allows a third trading partner to access said delivery order based on a status attribute in said delivery order.

24. The system according to claim 15, wherein said system is interfaced with a logistical application.

25. The system according to claim 24, wherein said logistical application is a transport application.

26. The system according to claim 24, wherein said logistical application is a monitoring application.

27. The system according to claim 15, wherein said means for creating delivery order further comprising a means for creating a one-to-many attribute in said delivery order.

28. The system according to claim 15, further comprising a means for creating a shipment using data from two or more purchase orders.

29. A system for sharing, tracking and updating supply chain purchasing transactional information, comprising:
a purchase order module for importing and viewing a purchase order having one or more user defined attributes, wherein said purchase order associated with a first trading partner; and
a delivery order module for creating and updating a corresponding delivery order having one or more user defined attributes, wherein said delivery order associated with a second trading partner.

30. The system according to claim 29, further comprising a security module for creating and assigning a filter to said second trading partner, said filter configured to query for said purchase order based on said user defined attributes for said purchase order.

31. The system according to claim 30 wherein said security module capable of creating a filter configured so that said filter allows a third trading partner to access said delivery order based on a third party attribute in said delivery order.

32. The system according to claim 30 wherein said security module capable of creating a filter configured so that said filter allows a third trading partner to access said delivery order based on a status attribute in said delivery order.

33. The system according to claim 29, further comprising a monitoring module for monitoring data contained in a delivery order.

34. The system according to claim 33, wherein said monitoring module configured so that said system can compare data contained in a delivery order and determines whether a business rule has been triggered.

35. The system according to claim 34, wherein said monitoring module configured so that a trading partner is notified when said business rule has been violated.

36. The system according to claim 29, wherein said delivery order module capable of importing data from a purchase order into a delivery order.

37. The system according to claim 29, wherein said system interfaced with a logistical application.

38. The system according to claim 37, wherein said logistical application is a transport application.

39. The system according to claim 37 wherein said logistical applications a monitoring application.

40. The system according to claim 29, wherein said corresponding delivery order module capable of creating a delivery order with a one-to-many attribute.

41. The system according to claim 29, wherein said corresponding delivery order module capable of creating a shipment using data from two or more purchase orders.

42. A system for sharing, tracking and updating supply chain purchasing transactional information, comprising:
a means for creating a purchase order having one or more user defined attributes, wherein said purchase order associated with a first supply chain trading partner; and
a means for creating a corresponding delivery order having one or more user defined attributes, wherein said corresponding delivery order associated with a second supply chain trading partner, said delivery order being accessible by said first trading partner.
